(19) United States
(12) Patent Application Publication
(10) Pub. No.: US 2004/0199740 A1
(43) Pub. Date: Oct. 7, 2004

(54) Adaptive and recursive compression of lossily compressible files

(75) Inventors: Jakke Makela, Turku (FI); Mikko Juhola, Muurla (FI); Kai Ojala, Oulu (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/408,495

(22) Filed: Apr. 7, 2003

(51) Int. Cl. G06F 12/00

(52) U.S. Cl. 711/170; 711/154

(57) ABSTRACT

A method for managing a memory 22 of an electronic device 20 within which user files Fᵢ are stored includes storing a new user file Fᵢ in the memory 22; discovering 46 that an unused memory portion 24 is less than a preset threshold; prioritizing 48 the stored user files Fᵢ; selecting 50 the user file Fᵢ with the highest priority; and compressing 52 the selected user file Fᵢ. The amount of unused memory 24 (now expanded) is again compared 54 to the threshold, and if unused memory 24 is lacking, the user files Fᵢ are again ordered 48, and the highest priority user file Fᵢ, which may or may not be the same as the last iteration, is selected 50 and compressed 52. The algorithm continues until the amount of unused memory 24 equals or exceeds the threshold. An electronic device 20 for practicing the method is also disclosed.

### TECHNICAL FIELD

These teachings relate generally to managing the storage of user files in a memory. It is particularly related to performing lossy data compression of files already stored in memory in order to free memory for storage of additional files.

### BACKGROUND

Portable consumer electronics such as mobile phones, digital cameras, personal digital assistants, MP3 players and other such digital convergence units (DCUs) increasingly incorporate image, video, audio, and other multimedia type files. These files are generally quite memory intensive as compared to other types of data files. Despite advances in density and capacity, memory remains a limiting factor in portable electronic devices. Various portable devices have employed floppy discs, memory sticks, flash memory, and microdrives to expand storage capacity. Consumers tend to prefer flash memory because memory management is more automated while the particular device is in use, requiring only occasional attention from the user such as when downloading to a CD or hard drive, for example. Consumers may find it frustrating to read a “memory full” or similar message on a digital camera or mobile phone, especially when the consumer is attempting to capture and store a new image. By the time the consumer reviews stored images and chooses which one(s) to delete, the new image sought to be captured may have evanesced.

Currently, widely available digital cameras provide image resolution of up to 2.1 megapixels. Such an image occupies approximately 1.2 MB of memory in JPEG compressed format. 35 mm cameras offer image resolution ranging from 8 to 35 megapixels, and digital camera resolution continues to close this gap with film resolution. While the cost of memory has decreased significantly and capacity has increased in recent years, trends suggest that the demand for memory (i.e., increased resolution, more images, integrated audio and video) will outpace the memory capacity of portable electronic devices such as DCUs. Without active memory management, the increasing resolution of multimedia files will yield sharper multimedia files stored within a particular portable device, but fewer of them.

Previous techniques to free up memory space by compressing existing files tended to treat each of the already-stored files alike. For example, if memory was full (or nearly so) and a new bitmap image (about 900 kB) was to be stored in memory, each of the already stored files would be compressed an equal amount until the requisite amount of memory was made available. This simple approach may enable storing of the new image, but necessarily degrades the quality of each and every one of the previously stored files.

Another approach, described in U.S. patent application Ser. No. 10/087,465 and co-owned by the assignee of this application, and herein incorporated by reference in its entirety, sets a priority of files relative to one another based on more than one criterion, wherein the user may assign certain criteria and other criteria may be assigned automatically. Files with the lowest priority may be transferred from a subject portable device to a PC, for example, and then deleted from flash memory to free memory space for additional images. File compression according to the present invention may use such a prioritization scheme or a user driven variable to determine which file to compress, and may compress the same file one or more times depending upon the need for space in unused memory.

This prioritization capability also sets the present invention apart from the type of algorithm described e.g. in the paper by Surendar Chandra, Carla Schlatter Ellis, and Amin Vahdat, “Multimedia Web Services for Mobile Clients Using Quality Aware Transcoding”, Proceedings of ACM WoWMoM, Seattle, Wash., USA, 1999. That approach differs fundamentally from the present invention in that it does not describe recursive compression (i.e. repeated compression of the same file). Also, the compression ratio in the mentioned paper is determined for each JPEG image separately, and not relative to the other stored images or user files as in the present invention.

### SUMMARY OF THE PREFERRED EMBODIMENTS

The foregoing and other problems are overcome, and other advantages are realized, in accordance with the presently preferred embodiments of these teachings. The preferred embodiment of the present invention includes a method for managing a memory of an electronic device for storing a plurality of user files. This method is initiated when a user stores a new user file in a memory of an electronic device such that an unused memory portion is less than a prescribed threshold value. The method then orders a user file stored in the memory relative to at least one other user file stored in the memory according to a compression priority. Preferably, all user files, including the newly stored user file, are ordered relative to one another. The method then includes selecting a user file with the highest compression priority, and compressing the selected user file. Once the selected file is compressed, a determination is made whether the unused memory at least equals the prescribed threshold value. If the amount of unused memory does not at least equal the prescribed threshold, then the above portion of the method concerning ordering the user files, selecting the file with the highest compression priority, compressing the selected file, and determining is repeated.

In accordance with another aspect of the invention, a portable electronic device includes a plurality of electronic user files and a memory for storing them. The device further includes a comparator for comparing a measure of unused memory to a prescribed threshold. The measure of unused memory may be, for example, a set number of bytes or a percentage of total memory available for storage of user files. The prescribed threshold may be fixed or variable; for example, a fixed number of bytes or an average of recently stored user file sizes. The device further includes circuitry for ordering the user files according to a compression priority, and software for lossily compressing a user file.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a block diagram of a portable electronic device according to the present invention.

FIG. 2 is a block diagram of a user file with a data portion and flags representing a priority for file compression that may be compared against other user files.

FIG. 3 is a flow diagram describing the method according to the preferred embodiment of the present invention.

FIGS. 4A-D depicts an image (4A) subject to three iterations (4B-D) of file compression by color reduction.

FIG. 5 depicts the image of FIG. 4A subject to six iterations of file compression by resolution reduction.

FIG. 6 depicts five sequential recursive file compressions of a 282 kB JPG image similar to FIG. 4A.

FIGS. 7A-C depicts three styles of file compression by bit-depth reduction of the image of FIG. 4A.

### DETAILED DESCRIPTION OF THE PREFERRED EMBODIMENTS

The present invention is directed to memory management where there may not be an immediate opportunity to download files to more voluminous storage medium such as a P.C. In a particular embodiment, the present invention is directed to freeing up space in a memory of a portable electronic device by compressing one or more files already stored within that memory. While some degradation of file quality (e.g., resolution) may be inherent in the compression, the present invention provides that the files selected for compression (and therefore possibly degradation), and the amount of compression performed on any individual file, is consistent with the user's expressed or presumed desires concerning retained image resolution. So long as lower priority images and files can be acceptably degraded, the effective amount of memory available for a new image is potentially greatly expanded.

A portable electronic device (PED) 20, such as a mobile phone with image capability, for example, may embody the present invention. Such a PED 20 is shown in block diagram form at FIG. 1. The PED 20 includes a memory 22 for storing a plurality of user files denoted F₁, F₂, F₃, etc., and referred to herein generally as Fᵢ. User files are those files stored by a user for direct experience, and include audio files, video files, image files and the like. As is evident, not all user files Fᵢ need have the same size. Each user file Fᵢ defines a size Lᵢ that may change over time depending upon certain criteria. An unused memory portion 24 is that part of memory 22 that is not occupied by any user files and that is immediately available for storing a new user file Fᵢ. Additional files that are not user files, such a system files, may be stored in the memory 22 or in a separate memory module. Regardless, the portion of the memory 22 relevant to this discussion is that portion available for storing user files Fᵢ.

The PED 20 preferably also includes a user interface 26 that comprises a display 28 such as an LCD screen on which instructions for the user and images from a user file may be displayed. The user interface 26 preferably also includes a plurality of user input devices such as buttons 30, whereby a user may choose from a selection presented on the display 28. The specific arrangement of the user interface 26 may vary. For example, the user interface 26 may be a touch screen wherein the user input devices are incorporated in the display 28, it may include a microphone 29 by which the PED 20 acts upon voice commands, or other such interfaces now existing or yet to be developed that are responsive to a user. In a preferred embodiment of the invention, the PED 20 comprises means to download files from memory 22 to another storage medium, wherein the means includes software and a conduit such as an internal or external antenna 32 for wireless communication via a wireless link 23 to a base station 25 that is a part of a communication network 21, or a cable for connection to a P.C. other type of computer. Such a PED 20 includes wireless circuitry 27. A mobile phone with image capability may also be referred to as a personal communicator having voice and data capability that includes a digital camera.

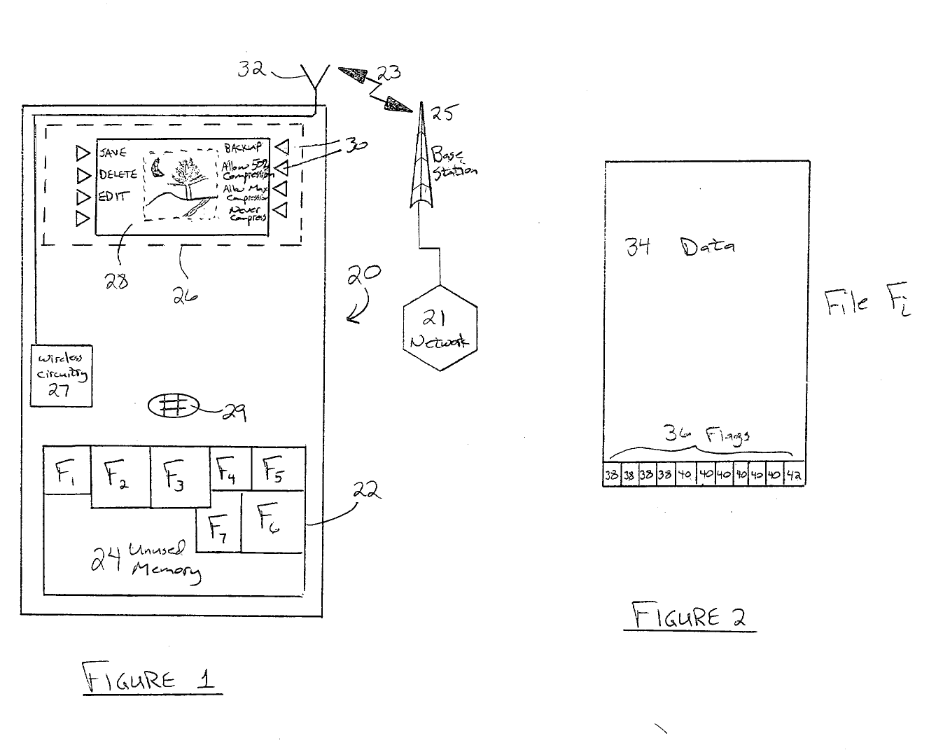

As shown in FIG. 2, each of the user files Fᵢ comprises a data portion 34 and a flag portion 36. Among other information, the data portion 34 comprises data bits that are translated into the audio, video, or pictorial image that the user directly experiences.

Certain user flags 38 of the flag portion 36 of the file Fᵢ denote selections made by a user at the user interface 26 concerning the particular file Fᵢ. For example, user flags 38 may denote that the user selected “Maximum Compression Allowed”, “Never Compress”, or “50% Compression Allowed”. These are examples and other defaults or user options maybe made available, at the PED designer's choice. Similar in concept to the user flags 38, automated flags 40 denote characteristics of the file Fᵢ that are automatically detected or tracked by the PED 20, such as age (since the user file Fᵢ was first stored or last accessed) and download status. The term “download” as referred to herein indicates transfer of data out of the PED 20. As an example of the automated flags 40, once the file Fᵢ has been downloaded, an automated flag 40 may change to reflect that particular file Fᵢ as having a lower priority (as compared to if the download flag 40 had not changed) since an archived version of the file Fᵢ is presumed to exist elsewhere. Similarly, older files may be presumed to be less important to a user than more recently loaded or accessed files, so the date that the user file Fᵢ was created (or last accessed or last modified) may drive other automated flags 40. The flags 38,40 enable the files Fᵢ to be prioritized for compression of the data portion 34 if necessary.

In the preferred embodiment, the memory 22 is managed and user files Fᵢ are compressed to drive the unused memory portion 24 to at least equal a prescribed threshold value, wherein that threshold value may be measured in bytes, a percent of memory 22 available for user file storage, or any other objectively measurable parameter. Any time the size of the unused memory portion 24 falls below the prescribed threshold, one or more files Fᵢ are selected to be compressed based upon the flags 38, 40. Preferably, but not byway of limitation, the user is queried at the user interface 26 for confirmation prior to any file Fᵢ being compressed. Anytime the amount of unused memory 24 falls below the prescribed threshold, a file compression sequence is initiated so that prospective images, not yet in memory 22, need never be lost due to lack of space in unused memory 24. To facilitate minimal delays in querying a user and to conserve battery power, the PED 20 preferably has a ready method by which to evaluate which file Fᵢ it will suggest for compression, and especially to what extent. An override flag 42 acts as a pointer for that purpose, readily directing the PED 20 to the file Fᵢ most likely to be compressed. Preferably, the override flag 42 is based on the total of all user flags 38 and automated flags 40, but may itself be ‘forced’ to indicate a particular file Fᵢ explicitly selected by the user for compression.

In an alternative embodiment, only the user may initiate file compression and the PED 20 suggests which file(s) to compress next and to what extent. However, certain users may not leave sufficient amounts of unused memory 24 for the next prospective image to be stored, thereby frustrating one advantage of the invention whereby there is preferably always sufficient unused memory 24 for another user file Fᵢ to be stored.

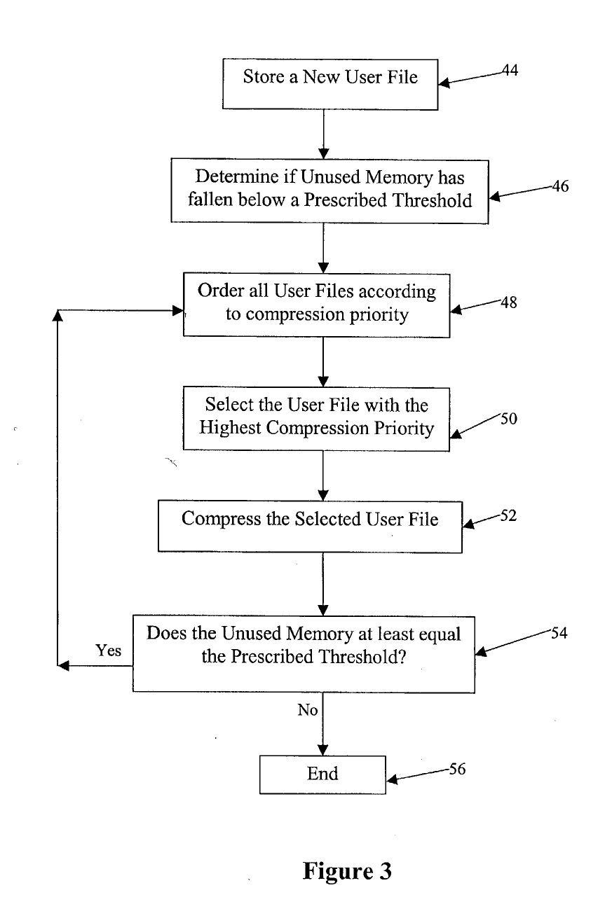

Specific regimens and criteria by which files Fᵢ may be prioritized are detailed in co-pending U.S. patent application Ser. No. 10/087,465, herein incorporated by reference in its entirety. The present invention is most effective when employed in conjunction with this or a similar file prioritization scheme. Some non-limiting examples of parameters by which to prioritize files for compression include: a file age parameter, a file size parameter, a value judgment parameter, a compression penalty parameter (related to power consumption), a user input override parameter, a file compressibility parameter (related to the amount of memory that would be freed in the next compression of that file), a number of times a file has been accessed parameter, and a floating time decay parameter. These parameters, or whichever of them may be used in a particular embodiment, may be scaled so that each defines a value of 1 or 0, and a mathematical sum of parameters would yield the particular user file next in line to be compressed. Alternatively, a flag 38, 40 may indicate how much memory will be freed in the next compression of that particular file Fᵢ. In that instance, the file that would free up just enough additional memory to meet the current need (as defined by a threshold value or by a new file seeking storage space in memory 22) may be selected for compression. For example, one file may be selected where an additional 25 kB of additional free memory space is needed, and another file may be selected for compression when 150 kB of additional free memory space is needed, all other parameters being equal. After storing numerous new file, eventually no single user file can be sufficiently compressed to open the necessary additional free memory space, and several files will need to be compressed marginally as described below in reference to FIG. 3.

The larger advantage of the present invention is that any file Fᵢ, such as one selected by a prioritization scheme or by the user, can be compressed selectively (adaptive compression), and any file Fᵢ may again be compressed (recursive compression) in a sequential iteration or at a later time to provide more unused memory for a new user file Fᵢ to be stored. A particular file Fᵢ may be recursively compressed to open sufficient memory so that the unused memory portion at least equals the prescribed threshold, may be compressed once to open a sufficient amount of memory based on a calculated amount of open memory needed, or may be compressed by a certain amount (based generally on the compression technique, say for example, 50% compression) and then re-ordered with the other stored user files. In the latter instance, recursive compression on a particular file Fᵢ may not occur until some time later when a different new user file Fᵢ was being stored.

The algorithm generally described above is illustrated at FIG. 3, a flow diagram depicting the method of the preferred embodiment. Management of memory within an electronic device such as a digital PED 20 according to the present invention can be thought to be initiated when a user stores a new user file (block 44), since that action occupies (previously unused) memory and may trigger the need for compression of one or more user files. As described above, the present invention may also initiate the selection of files to compress when a user seeks to store a file that will exceed the capacity of the memory 22. In the preferred embodiment of FIG. 3, the PED 20 determines (discovers) that the amount of unused memory 24, after storage of the new user file Fᵢ, has fallen below a prescribed threshold (block 46). The prescribed threshold may be a fixed value such as a fixed number of bytes, or a fixed percentage of total memory available for user files. The prescribed threshold may also be based on a size of one or more user files, such as an average size of the last five stored user files, the largest of the last three stored user files, 10% larger than the most commonly stored user file size, etc., wherein the size of the user files used to determine the prescribed threshold is preferably the size as originally stored, not as may currently exist after compression.

Once a determination (block 46) of a shortfall in the unused memory 24 is made, all user files (including the newly stored user file from block 44) are ordered according to a compression priority (block 48). This is preferably done according to the flag scheme described above. The file with the highest compression priority is selected (block 50). Whether the selected file bears the highest, the lowest, or a middling sequential number is irrelevant; the compression priority is to distinguish files for purposes of compression. The claims herein are not avoided by manipulating number sequences of the compression priority in a manner that does not reflect the actual priority and selection of files for compression purposes. Similarly, the compression priority need not be exclusively or even specifically for comparing files for compression purposes. Another file comparison scheme that may already be in place for another purpose may be used as a compression priority scheme in accordance with the present invention. By whatever means selected, the PED 20 then compresses the selected user file Fᵢ (block 52). Preferably, this compression is in a single increment (i.e., 50% reduction in file size, dropping from 16 million colors to 256 colors, etc.) according to the compression technique selected, rather than a compression of the file to a minimal allowable compression size. After this incremental compression, the now expanded unused memory portion is compared to the threshold value (block 54). If the comparison is neutral or positive, the algorithm of FIG. 3 ends (block 56). If instead the unused memory portion 24 still remains less than the threshold value, the user files Fᵢ are re-ordered according to the compression priority (block 48) and the relevant parts of the algorithm are repeated until sufficient compressions have been done to release an adequate amount of memory.

Specific means by which files may be compressed include any now known or later developed that enable lossy data compression. Examples include reducing the number of colors in an image, changing the bit-depth (e.g., YUV format in jpg coded files), reducing resolution, reducing image intensity and depth information (such as limiting the number of bits per color, using intelligent computing methods such as filtering to extract and retain only the most necessary visual information), and iterative (recursive) compression of the same file or compressing the file at an increased compression rate. Similar compression techniques are available for audio files, whereby more subtle audio portions (specific instruments, background vocals, etc.) are lost first and only the most basic tonal structure remains after maximum compression (MIDI) or whereby highest frequencies are lost first (MP3) or whereby bit rate of audio is reduced (WAV) or whereby audio information frequency band is selected to by using vocal track model (speech coding).

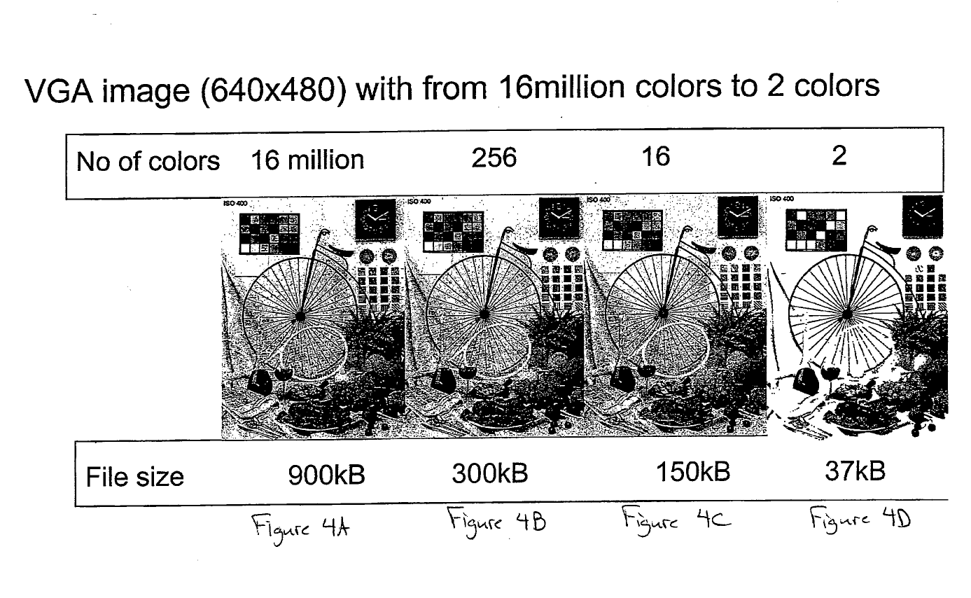

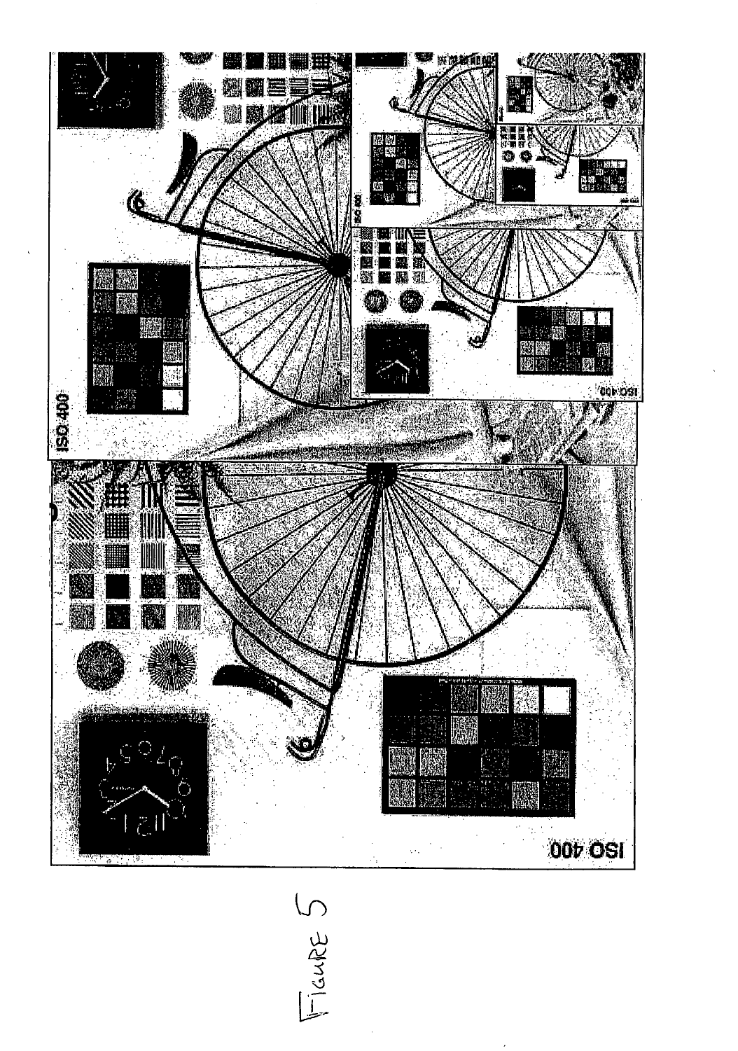

Certain of the relevant details of FIGS. 4-11 may be visible when viewed on the user interface 26 of a PED 20 but may not be evident in the print resolution available herein, so image resolution will be described textually for a better appreciation of differences not otherwise evident. File sizes are approximate and are given for comparison purposes.

Some common image file compression techniques are given in FIGS. 4-7. FIGS. 4A-D depicts sequential compression of a bitmap image (BMP) wherein the extent of the available color palate is reduced for each sequential image. This file compression technique makes available large amounts of memory, especially the initial color reductions. FIG. 4A is a VGA image (640×480) that uses a palate of 16 million colors, and the corresponding image takes 900 kB of memory. FIG. 4B uses a palate of 256 colors and takes 300 kB of memory, and there is little reduction in visible quality when viewed on the size screens typically encountered on a user interface 26 of a portable electronic devices 20. FIG. 4C is a 16 color palate image occupying 150 kB, and FIG. 4D is a 2 color image occupying only 37 kB of memory. Quality degradations between FIGS. 4B and 4C, and between 4C and 4D are readily apparent on most user interfaces 26. The method of the present invention, as described with reference to FIG. 3, may iteratively reduce the color palate of an image similar to the sequential degradation shown in the series of FIG. 4A-D, or may degrade immediately from, for example, FIG. 4A to FIG. 4C or 4D. The more preferred method is to iteratively degrade, re-prioritize the user files, and further reduce the quality of the already degraded image only if that same image remains at the lowest priority. Each iteration of file compression (i.e., from FIG. 4A to 4B; from 4B to 4C; etc.) represents an iteration of the process blocks of FIG. 3. In this manner, the method maintains a more uniform quality among the existing images that are not reduced to thumbnails, as described below. An alternative method is to calculate the amount of memory that must be made available in order to satisfy the prescribed threshold and compress the selected user file Fᵢ at least that amount. This alternative approach is less power intensive for the battery operated PED 20, but tends to wide variations in the resolution of stored images (user files) within the PED 20. Of course, a user selection may override either of the above suggested default scheme as determined by a designer of the PED 20.

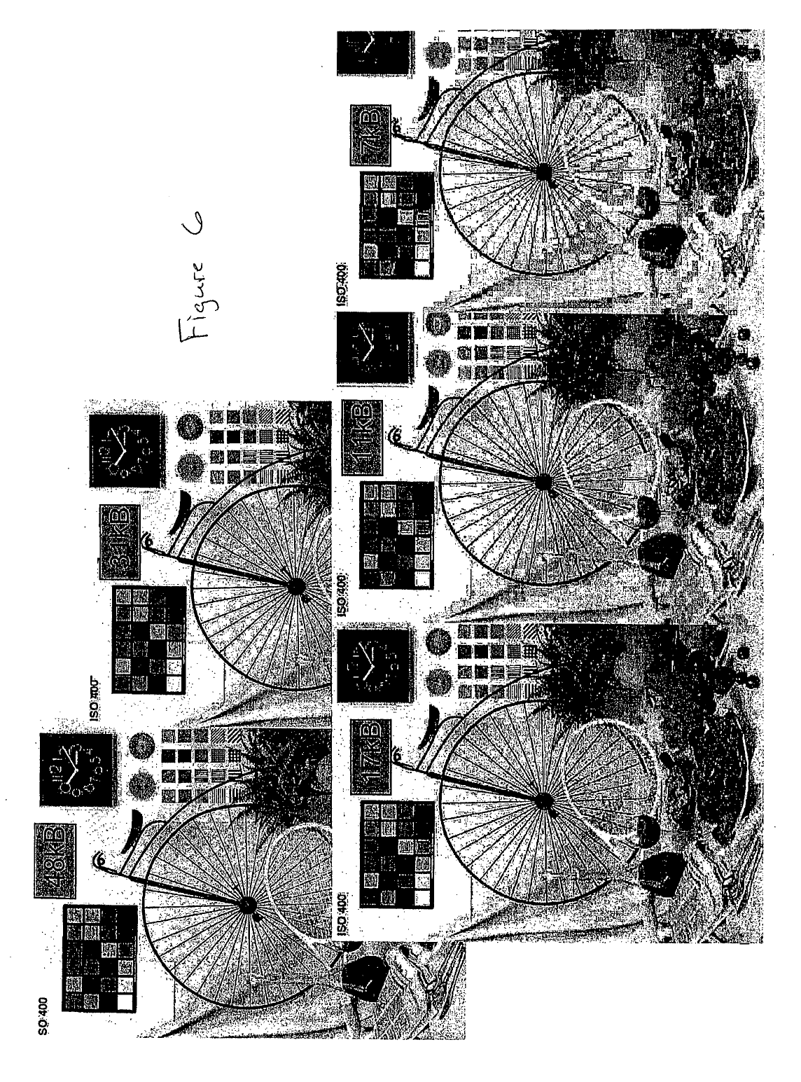

FIG. 5 depicts a series of images wherein resolution is sequentially reduced for each smaller sized image from VGA to 120×90 JPG. The images are overlain smallest above the largest, so half of each separate image (except the smallest) within FIG. 5 is obscured. The obscured lower half of each image (other than the smallest) is not representative of the compression technique. The highest resolution image of FIG. 5 is a VGA image (640×480) occupying 57 kB of memory. The next best resolution is 480×360 and occupies 27 kB; followed by 320×240 occupying 15 kB; 240×180 occupying 9 kB; 160×120 occupying 5 kB; and the poorest resolution is 120×90 occupying only 3 kB of memory. As compared to color reduction, this technique frees much less memory space. However, much of the quality losses may not be visible to a typical user unless downloaded onto a viewing screen much larger than those typically available on a portable electronic device 20.

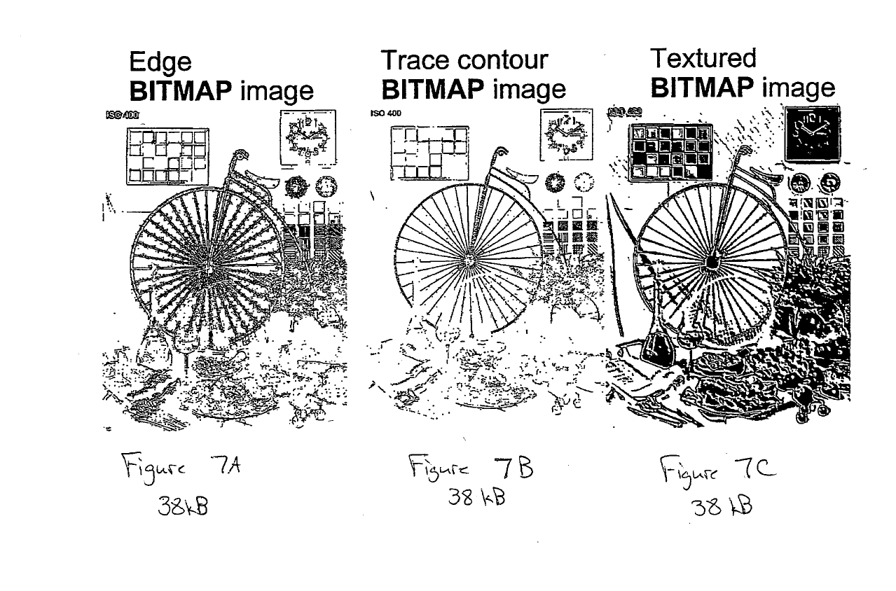

FIG. 6 depicts a series of images recursively compressed from an original JPG file occupying 282 kB of memory. Each image of FIG. 6 is distinguishable by a unique memory size appended onto the image. The first compression reduced file size to 48 kB, and the next compression to 31 kB. Quality losses become readily apparent at the third recursive compression that yields a file of 17 kB. Continued visible degradations are evident in further compressions to 11 kB and 7 kB, respectively. As with color reduction, these compressions may be done sequentially as recursive compression to the same file, or the original file of 282 kB may be compressed in one step to, for example, 11 kB without transiting the intermediate compression steps. The latter approach may consume less power in a battery powered PED 20 than a recursive technique, but it tends to induce a wider distribution of image quality over all user file images stored in memory than may be optimal. Instead, re-prioritizing each file after a single compression resets the queue for files to be compressed. Any individual file is still subject to recursive compression, but it becomes much less likely that a particular file Fᵢ will be reduced from high resolution to very low resolution during the storing of a single new user file (unless the particular file Fᵢ has been downloaded).

FIGS. 7A-C depict images resulting from different compressions of the bitmap image of FIG. 4A (900 kB) using bit depth reduction assisted by smart image processing. Each of the images of FIGS. 7A-C occupies 38 kB of memory, nearly identical to the two-color image of FIG. 4D, but each retaining more colors overall and more data in particular areas. A user may have the option to compress the image of FIG. 4A by the methods resulting in FIG. 7A, 7B or 7C before compression begins, or the selection may be a default that may depend upon features of the particular image to be compressed. If the user makes the selection manually, it may be made either when setting initial user preferences as when a PED 20 is first initialized, or upon a prompt from the PED 20 immediately prior to a compression being executed on a particular user file Fᵢ.

As a comparison of the present invention as compared to the prior art ‘cheesecutter’ method of memory management, assume an example of four figures are stored in a memory of a PED 20, and that additional memory needs to be made available so that the total memory occupied by these stored images cannot exceed 40 kB. Each image as originally stored occupies 300 kB of memory, or 1.2 MB total, which is the assumed total memory capacity of the PED 20. A reduction in used memory from 1.2 MB to 40 kB, without file deletion, is chosen to better illustrate advantages of the present invention, and is not likely to ever be encountered in actual practice.

The cheesecutter approach treats each image alike, partitions 40 kB that is proposed to be available for storage into 10 kB segments, and fills each segment with one of the images sufficiently compressed (10 kB each) for that space. Each of the four stored images are not distinguished under the cheesecutter scheme, and each suffers an equal quality reduction in the resulting compression.

The adaptive scheme instead accesses the flags 38, 40, 42 associated with each image to prioritize that should be compressed. Assume the following preconditions for the purposes of this illustration: the first image is a recently stored image; the second image is an older image; the third image and fourth image have each been downloaded (backed up); and that appropriate flags for the relevant user files indicate the above preconditions.

According to the first two iterations of the flow diagram of FIG. 3, the third and fourth images will be compressed, for example, to a thumbnail sized image occupying 2 kB each. Other flags not presupposed in this example may determine the order of these compressions. This leaves 596 kB of unused memory, wherein the threshold is 1.16 MB (40 kB occupied memory of 1.2 MB total memory). No further compression may be taken on the third and fourth images of FIGS. 10-11, a status that may then be reflected in one of the automated flags 40 to quicken further ordering of the user files Fᵢ. The next iteration of the flowchart of FIG. 3 selects the second image because an automated flag 40 indicates it is older, and a compression reduces it to 11 kB, for example. This iteration yields a total unused memory portion of 885 kB, which is 275 kB shy of the threshold 1.16 MB. An automated flag 40 may then be set for the second image that it can accept no further compression until downloaded, which further reduces power requirements and speeds execution for ordering user files Fᵢ. The final iteration selects the first image, compresses it to 25 kB (for example), and satisfies the threshold open memory of 1.16 MB.

In summary, the adaptive/recursive scheme of the present invention provides less memory space to the downloaded images (third and fourth images), about the same to the older but not downloaded image (second image), and 150% more storage space for the more recent image that has not been downloaded (first image) as compared to the cheesecutter scheme. Where memory storage space translates roughly into image quality or resolution, the advantages of the present invention become clear. The adaptive and recursive scheme of the present invention partitions the effectively available memory in a manner that preserves quality of images that are of a higher priority (first and second images), without completely deleting any of the lowest priority images (third and fourth images) stored as user files.

While described in the context of presently preferred embodiments, those skilled in the art should appreciate that various modifications of and alterations to the foregoing embodiments can be made, and that all such modifications and alterations remain within the scope of this invention. Examples herein are stipulated as illustrative and not exhaustive.

What is claimed is:

1. A method for managing a memory of an electronic device for storing a plurality of user files, comprising:
determining that an unused memory portion is less than a threshold value;
ordering a user file stored in the memory relative to at least one other user file stored in the memory according to a compression priority;
selecting a user file for compression according to the compression priority;
compressing the selected user file;
comparing the unused memory portion to the threshold value; and
repeating the steps of ordering, selecting, compressing and comparing if the unused memory portion does not at least equal the prescribed threshold.

2. The method of claim 1 wherein determining that an unused memory portion is less than a threshold value is executed in response to the storage of a new user file.

3. The method of claim 1 wherein determining that an unused memory portion is less than a threshold value comprises calculating a difference between the unused memory portion and the threshold value.

4. The method of claim 3 wherein compressing the selected user file comprises compressing the selected user file by an amount selected to at least equal the difference.

5. The method of claim 1 wherein the threshold value is dependent upon a size of at least one user file.

6. The method of claim 1 wherein the threshold value is a fixed value.

7. The method of claim 1 wherein ordering a user file stored in the memory comprises ordering all user files of a same type stored in memory relative to one another according to a compression priority.

8. The method of claim 1 wherein compressing the selected user file includes compressing to no less than a minimum file size.

9. The method of claim 8 wherein the minimum file size varies depending upon at least one parameter associated with the selected user file.

10. The method of claim 9 wherein the at least one parameter comprises at least one of file type, download status, selection made by a user, and time since the selected file was last accessed by the user.

11. The method of claim 1 wherein ordering a user file stored in the memory comprises providing a digital indicator of the user file that is the next to be compressed.

12. The method of claim 11 wherein selecting a user file comprises selecting the file that bears the digital indicator.

13. A portable electronic device comprising:
a memory for storing a plurality of electronic user files;
a comparator for comparing a measure of unused memory to a threshold value;
circuitry for ordering the user files according to a compression priority; and
software for lossily compressing a user file.

14. The portable electronic device of claim 13 further comprising a user interface whereby a user may make at least one input for a particular user file that bears on compression priority.

15. The portable electronic device of claim 14 wherein the software does not lossily compress a user file unless enabled by a user via the user interface.

16. The portable electronic device of claim 13 further comprising a conduit to electronically download a user file to a different device, and further wherein the software enables lossy compression of a user file that has been downloaded to a greater extent than a user file that has not been downloaded.

17. The portable electronic device of claim 13 wherein each user file comprises a data section and a flag section, and wherein the flag section denotes compression priority.

18. The portable electronic device of claim 17 wherein at least one electronic bit of the flag section denotes a highest compression priority for a user file.

19. A mobile communications device comprising:
a memory for storing a plurality of electronic user files;
a user interface whereby a user may input a command;
wireless circuitry for communicating over a wireless network;
a conduit for downloading a user file to another device over the wireless network;
a comparator for comparing a measure of unused memory to a threshold value;
circuitry for ordering the user files according to a compression priority; and
software for lossily compressing a user file.
